(19) United States
(12) Patent Application Publication
(10) Pub. No.: US 2024/0175764 A1
(43) Pub. Date: May 30, 2024

(54) TEMPERATURE SENSOR

(71) Applicant: Panasonic Intellectual Property Management Co., Ltd., Osaka (JP)

(72) Inventors: Norimichi NOGUCHI, Osaka (JP); Daisuke SUETSUGU, Osaka (JP); Yuki OHYAMA, Fukui (JP); Kazuhiro KANDA, Fukui (JP); Yuji YASUOKA, Osaka (JP)

(21) Appl. No.: 18/549,305

(22) PCT Filed: Mar. 28, 2022
(86) PCT No.: PCT/JP2022/015105

§ 371 Date: Sep. 6, 2023

(30) Foreign Application Priority Data
Mar. 31, 2021 (JP) 2021-061520

(51) Int. Cl. G01K 7/16

(52) U.S. Cl. CPC G01K 7/16

(57) ABSTRACT

A temperature sensor according to the present disclosure includes an alumina substrate, a planarization film, a first resistive portion, and at least one second resistive portion. The planarization film contains alumina as a main component thereof and is formed on the alumina substrate. The first resistive portion is formed on the planarization film. The at least one second resistive portion is formed on the planarization film and forms a bridge circuit along with the first resistive portion.

### TECHNICAL FIELD

The present disclosure generally relates to a temperature sensor, and more particularly relates to a temperature sensor including a first resistive portion and a second resistive portion.

### BACKGROUND ART

Patent Literature 1 discloses a temperature detection device (temperature sensor) including a first resistor (first resistive portion) subjected to boron treatment and a second resistor (second resistive portion) having a temperature coefficient with a greater absolute value than the first resistor.

The temperature detection device of Patent Literature 1 detects a temperature based on the difference in resistance value between the first and second resistors.

The temperature detection device of Patent Literature 1 may cause a decline in temperature detection accuracy.

### CITATION LIST

### Patent Literature

Patent Literature 1: WO 2014/200011 A1

### SUMMARY OF INVENTION

It is therefore an object of the present disclosure to provide a temperature sensor which may reduce the chances of causing a decline in temperature detection accuracy.

A temperature sensor according to an aspect of the present disclosure includes an alumina substrate, a planarization film, a first resistive portion, and at least one second resistive portion. The planarization film contains alumina as a main component thereof and is formed on the alumina substrate. The first resistive portion is formed on the planarization film. The at least one second resistive portion is formed on the planarization film and forms a bridge circuit along with the first resistive portion.

### BRIEF DESCRIPTION OF DRAWINGS

FIG. 1 is a perspective view illustrating the appearance of a temperature sensor according to an exemplary embodiment;

FIG. 2 is a plan view of the temperature sensor;

FIG. 3 is an enlarged view of the part A1, shown in FIG. 2, of the temperature sensor;

FIG. 4 is a cross-sectional view of the temperature sensor as taken along the plane X1-X1 shown in FIG. 1;

FIG. 5 is a cross-sectional view of the temperature sensor as taken along the plane X2-X2 shown in FIG. 1;

FIG. 6 is a cross-sectional view of the temperature sensor as taken along the plane Y1-Y1 shown in FIG. 1;

FIG. 7 is a schematic circuit diagram of the temperature sensor; and

FIG. 8 is another plan view of the temperature sensor.

### DESCRIPTION OF EMBODIMENTS

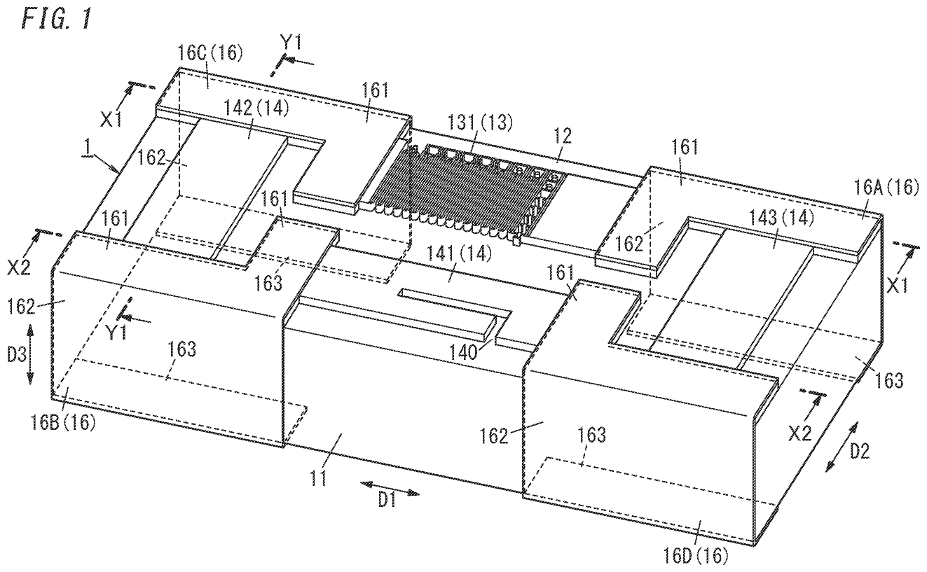

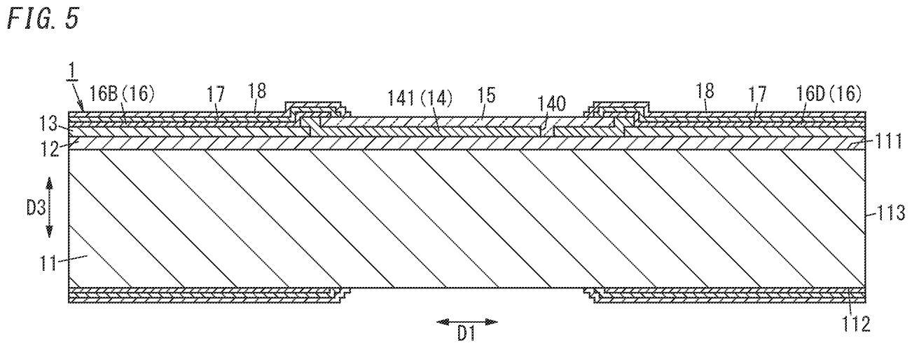

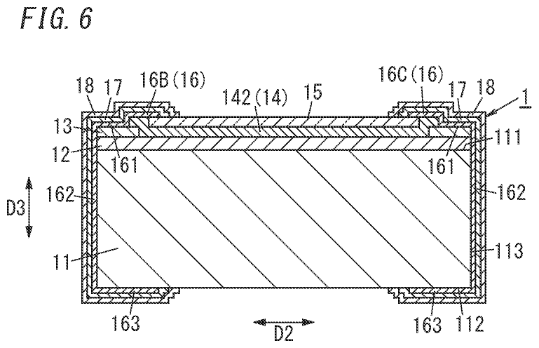

A temperature sensor 1 according to an exemplary embodiment will be described with reference to FIGS. 1-8. Note that FIGS. 1-6 and FIG. 8 to be referred to in the following description of embodiments are all schematic representations. Thus, the ratio of the dimensions (including thicknesses) of respective constituent elements illustrated on the drawings does not always reflect their actual dimensional ratio.

### Embodiment

### (1) Overview

A temperature sensor 1 according to an exemplary embodiment is an electronic component for use to measure the temperature. The temperature sensor 1 may be, for example, a surface-mounted chip component to be mounted onto the surface (mounting surface) of an external board (not shown) via a plurality of (e.g., four) electrode portions 16 to be described later. The external board may be a printed wiring board, for example.

As shown in FIG. 1, the temperature sensor 1 according to this embodiment includes a supporting substrate 11 (alumina substrate), a planarization film 12, a first resistive portion 131, and at least one (e.g., three in the example illustrated in FIG. 1) second resistive portion 141, 142, 143. The planarization film 12 contains alumina as a main component thereof and is formed on the supporting substrate 11. The first resistive portion 131 is formed on the planarization film 12. The second resistive portions 141, 142, 143 are formed on the planarization film 12 and form a bridge circuit along with the first resistive portion 131.

In the temperature sensor 1 according to this embodiment, the first resistive portion 131 and the second resistive portions 141, 142, 143 are formed on the planarization film 12 that has been formed on the supporting substrate 11 as described above. This allows the first resistive portion 131 and the second resistive portions 141, 142, 143 to be planarized more perfectly than in a situation where the first resistive portion 131 and the second resistive portions 141, 142, 143 are formed directly on the supporting substrate 11 with no planarization film 12 interposed between the resistive portions 131, 141, 142, 143 and the substrate 11. This reduces the chances of causing a decline in the temperature detection accuracy. In addition, in the temperature sensor 1 according to this embodiment, the planarization film 12 contains alumina as a main component thereof as described above, thus increasing the degree of adhesion between the supporting substrate 11 that is an alumina substrate and the planarization film 12.

As used herein, the “main component of the planarization film” refers to a component, which accounts for the largest proportion of the planarization film, out of multiple components of the planarization film. In the temperature sensor 1 according to this embodiment, the main component of the planarization film 12 is alumina, and therefore, alumina accounts for the largest proportion of the planarization film 12.

### (2) Details

Next, the temperature sensor 1 according to this embodiment will be described in further detail with reference to FIGS. 1-7.

### (2.1) Structure of Temperature Sensor

First, the structure of the temperature sensor 1 according to this embodiment will be described with reference to FIGS. 1-6.

As shown in FIG. 1, the temperature sensor 1 according to this embodiment is formed in the shape of a rectangular parallelepiped, which is elongate in a first direction D1. In the following description, the length (longitudinal axis) of the temperature sensor 1 is supposed to be aligned with the first direction D1, the width (latitudinal axis) of the temperature sensor 1 is supposed to be aligned with a second direction D2, and the thickness of the temperature sensor 1 is supposed to be aligned with a third direction D3. However, these directions should not be construed as limiting the directions in which the temperature sensor 1 is supposed to be used. In addition, the arrows indicating these directions D1, D2, and D3 on the drawings are shown there only as an assistant to description and are all insubstantial ones. In this embodiment, the first direction D1, the second direction D2, and the third direction D3 intersect with each other at right angles.

As shown in FIGS. 1-6, the temperature sensor 1 according to this embodiment includes the supporting substrate 11, the planarization film 12, a first resistive layer 13, and a second resistive layer 14. In addition, the temperature sensor 1 further includes a protective coating 15, a plurality of (e.g., four) electrode portions 16, a plurality of (e.g., four in the example illustrated in FIGS. 1-6) first plating layers 17, and a plurality of (e.g., four in the example illustrated in FIGS. 1-6) second plating layers 18.

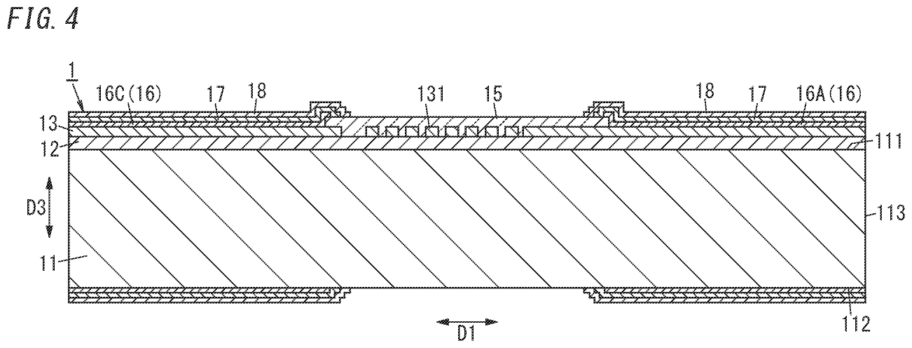

The supporting substrate 11 may be, for example, a ceramic substrate. A material for the ceramic substrate may be, for example, sintered alumina with an alumina content equal to or greater than 96%. That is to say, the supporting substrate 11 is an alumina substrate that contains sintered alumina as its material. When viewed in plan in the third direction D3 aligned with the thickness of the temperature sensor 1, the supporting substrate 11 has the shape of a rectangle which is elongate in the first direction D1 that is aligned with the longitudinal axis of the temperature sensor 1. As shown in FIGS. 4-6, the supporting substrate 11 has a first principal surface 111, a second principal surface 112, and outer peripheral surfaces 113. Each of the first principal surface 111 and the second principal surface 112 is a plane aligned with both the first direction D1 and the second direction D2 defining the width (latitudinal axis) of the temperature sensor 1. In other words, each of the first principal surface 111 and the second principal surface 112 is a plane intersecting (at right angles) with the third direction D3. The first principal surface 111 and the second principal surface 112 face each other in the third direction D3. The outer peripheral surfaces 113 consist of four side surfaces that connect the first principal surface 111 and the second principal surface 112 to each other. Each of the four side surfaces is a plane aligned with the third direction D3.

As shown in FIGS. 4-6, the planarization film 12 is formed on the first principal surface 111 of the supporting substrate 11. The planarization film 12 may contain, for example, alumina (Al₂O₃) as a main component thereof. That is to say, alumina accounts for a larger proportion of the planarization film 12 than any other component thereof and may account for 50% by mass or more of the planarization film 12. The alumina content of the planarization film 12 is preferably equal to or greater than 80% by mass and more preferably equal to or greater than 90% by mass. In the temperature sensor 1 according to this embodiment, the planarization film 12 contains a filler. The filler includes at least one material selected from the group consisting of, for example, zinc oxide (ZnO), magnesium oxide (MgO), beryllium oxide (BeO), aluminum nitride (AlN), boron nitride (BN), silicon nitride (SiNx), and diamond. This enables bringing the thermal conductivity and coefficient of linear expansion of the planarization film 12 closer to the thermal conductivity and coefficient of linear expansion of the alumina substrate 11.

As described above, the planarization film 12 contains alumina as a main component thereof. Thus, forming the planarization film 12 on the supporting substrate 11 as an alumina substrate reduces, even under heat load, the chances of causing a difference in coefficient of thermal expansion between the supporting substrate 11 and the planarization film 12. In addition, making the supporting substrate 11 and the planarization film 12 of similar materials allows the planarization film 12, as well as the supporting substrate 11, to have excellent insulation properties and thermal conductivity.

With this regard, the surface of a generally used alumina substrate has an unevenness on the order of a few hundred nm to several thousand nm due to the irregular shapes of alumina particles that form sintered alumina. That is why the thickness of the planarization film 12 is preferably equal to or greater than the height of the unevenness. Specifically, the planarization film 12 preferably has a thickness equal to or greater than 1.0 μm, for example. This allows the first resistive layer 13 and the second resistive layer 14 to be formed on the surface (upper surface) of the planarization film 12 that had had its unevenness reduced.

As shown in FIGS. 4-6, the first resistive layer 13 is formed on the planarization film 12. A material for the first resistive layer 13 may include, for example, platinum (Pt). The first resistive layer 13 may be, for example, a sputtered film formed by sputtering.

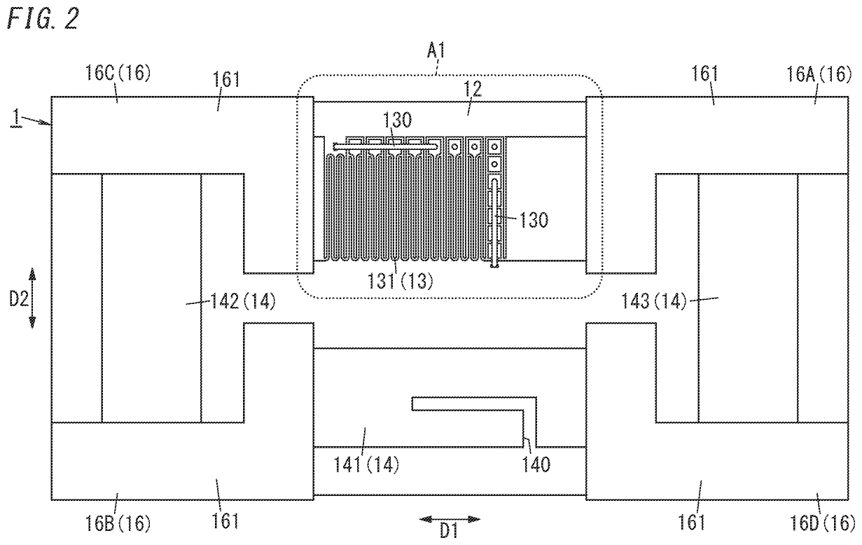

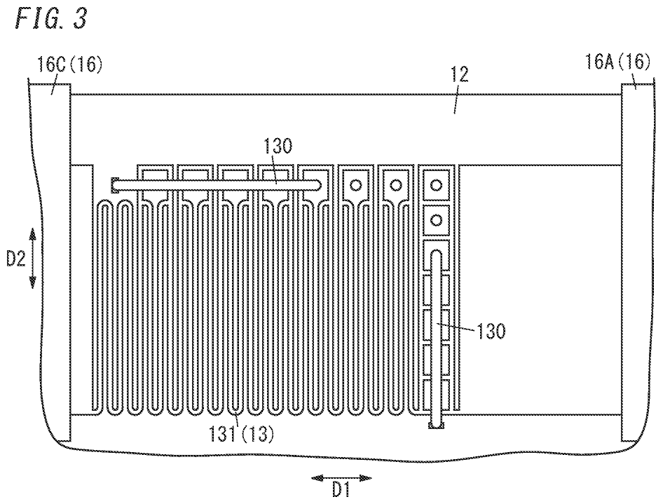

The first resistive layer 13 includes the first resistive portion 131 as a resistance temperature detector. That is to say, the first resistive portion 131 is formed on the planarization film 12 and a material for the first resistive portion 131 is platinum. As shown in FIGS. 2 and 3, the first resistive portion 131 is formed in a meandering shape, i.e., to meander in the first direction D1 when viewed in plan in the third direction D3. In other words, the first resistive portion 131 is formed in the shape of a river that meanders in the first direction D1 when viewed in plan in the third direction D3.

As shown in FIGS. 4-6, the second resistive layer 14 is formed on the planarization film 12. A material for the second resistive layer 14 may be, for example, an NiCrAlSi alloy. In the second resistive layer 14, the ratio by weight of nickel (Ni) to chromium (Cr) may be, for example, equal to or greater than 44/55 and equal to or less than 55/44. Also, in the second resistive layer 14, the proportion of aluminum (Al) to the total weight thereof may be, for example, equal to or greater than 10% by weight and equal to or less than 18% by weight. Furthermore, in the second resistive layer 14, the proportion of silicon (Si) to the total weight thereof may be, for example, equal to or greater than 2% by weight and equal to or less than 6% by weight. The second resistive layer 14 may be, for example, a sputtered film formed by sputtering.

As shown in FIGS. 1 and 2, the second resistive layer 14 includes a plurality of (e.g., three in the example illustrated in FIGS. 1 and 2) second resistive portions 141, 142, 143. That is to say, the second resistive portions 141, 142, 143 are formed on the planarization film 12 and the material for the second resistive portions 141, 142, 143 includes the NiCrAlSi alloy. Each of the plurality of second resistive portions 141, 142, 143 is formed in the shape of a rectangle which is elongate in one direction when viewed in plan in the third direction D3. More specifically, the second resistive portion 141 out of the plurality of second resistive portions 141, 142, 143 is formed in the shape of a rectangle elongate in the first direction D1. On the other hand, each of the two second resistive portions 142, 143, out of the plurality of second resistive portions 141, 142, 143, is formed in the shape of a rectangle elongate in the second direction D2.

The two second resistive portions 142, 143, out of the plurality of second resistive portions 141, 142, 143, are arranged at both ends of the supporting substrate 11 in the first direction D1 when viewed in plan in the third direction D3. That is to say, the two second resistive portions 142, 143 are arranged side by side in the first direction D1. The other second resistive portion 141, out of the plurality of second resistive portions 141, 142, 143, is disposed at one end (i.e., the lower end in FIG. 2) of the supporting substrate 11 in the second direction D2 when viewed in plan in the third direction D3. At the other end (i.e., the upper end in FIG. 2) of the supporting substrate 11 in the second direction D2, disposed is the first resistive portion 131. That is to say, the first resistive portion 131 and the second resistive portion 141 are arranged side by side in the second direction D2.

In this embodiment, the material for the first resistive portion 131 includes platinum as described above. On the other hand, the material for the second resistive portions 141, 142, 143 includes the NiCrAlSi alloy as described above. Thus, in the temperature sensor 1 according to this embodiment, the temperature coefficient of resistance of the first resistive portion 131 is greater than the temperature coefficient of resistance of the second resistive portions 141, 142, 143. This allows the first resistive portion 131 to detect a variation in temperature.

The protective coating 15 is a coating for protecting the first resistive layer 13 and the second resistive layer 14. As shown in FIGS. 4-6, the protective coating 15 is formed to cover the first resistive layer 13 and the second resistive layer 14. A material for the protective coating 15 may be, for example, silicon dioxide (SiO₂). In the temperature sensor 1 according to this embodiment, part, where the first resistive portion 131 is connected to the electrode portion 16 (to be described later), of the first resistive layer 13 is not covered with the protective coating 15. In addition, in this temperature sensor 1, respective parts, where the plurality of second resistive portions 141, 142, 143 are connected to the electrode portions 16, of the second resistive layer 14 are not covered with the protective coating 15, either.

As shown in FIG. 1, the plurality of electrode portions 16 are formed at the four corners of the supporting substrate 11. A material for the plurality of electrode portions 16 may be, for example, a copper-nickel (CuNi) based alloy. Each of the plurality of electrode portions 16 includes an upper surface electrode 161, an end surface electrode 162, and a lower surface electrode 163. The upper surface electrode 161 is formed on the first principal surface 111 of the supporting substrate 11 and is connected to either the part, connected to the first resistive portion 131, of the first resistive layer 13 or the respective parts, connected to the second resistive portions 141, 142, 143, of the second resistive layer 14. The end surface electrode 162 is formed to cover a longitudinal one of the outer peripheral surfaces 113 of the supporting substrate 11 along the longitudinal axis (aligned with the first direction D1) of the supporting substrate 11. The lower surface electrode 163 is formed on the second principal surface 112 of the supporting substrate 11. Each of the plurality of electrode portions 16 is formed in a U-shape when viewed in plan in the first direction D1. Each of the plurality of electrode portions 16 may be, for example, a sputtered film formed by sputtering.

The plurality of electrode portions 16 includes a first electrode portion 16A, a second electrode portion 16B, a third electrode portion 16C, and a fourth electrode portion 16D. The first electrode portion 16A may be used as, for example, a power supply terminal. The second electrode portion 16B may be used as, for example, a ground terminal. The third electrode portion 16C may be used as, for example, a first output terminal. The fourth electrode portion 16D may be used as, for example, a second output terminal. That is to say, DC power is supplied from a power supply device (not shown) to the temperature sensor 1 according to this embodiment such that the first electrode portion 16A serves as a cathode (positive electrode) and the second electrode portion 16B serves as an anode (negative electrode).

Each of the plurality of first plating layers 17 may be, for example, an electroplated copper layer. Each of the plurality of first plating layers 17 is formed to cover a corresponding one of the plurality of electrode portions 16. That is to say, each of the plurality of first plating layers 17 covers the upper surface electrode 161, end surface electrode 162, and lower surface electrode 163 of the corresponding electrode portion 16. Each of the plurality of first plating layers 17 is formed in a U-shape when viewed in plan in the first direction D1.

Each of the plurality of second plating layers 18 may be, for example, an electroplated tin layer. Each of the plurality of second plating layers 18 is formed to cover a corresponding one of the plurality of first plating layers 17. Each of the plurality of second plating layers 18 is formed in a U-shape when viewed in plan in the first direction D1.

### (2.2) Circuit Configuration for Temperature Sensor

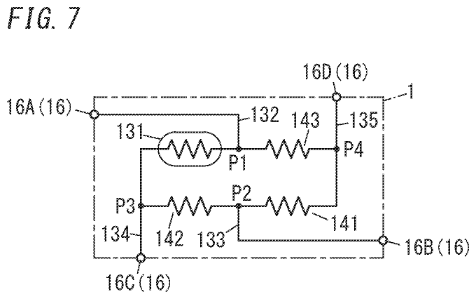

Next, a circuit configuration for the temperature sensor 1 according to this embodiment will be described with reference to FIG. 7.

As shown in FIG. 7, the temperature sensor 1 according to this embodiment includes a first resistive portion 131 and a plurality of (e.g., three in the example illustrated in FIG. 7) second resistive portions 141, 142, 143. The temperature sensor 1 also includes a first electrode portion 16A, a second electrode portion 16B, a third electrode portion 16C, and a fourth electrode portion 16D. As described above, the first electrode portion 16A is a power supply terminal, the second electrode portion 16B is a ground terminal, the third electrode portion 16C is a first output terminal, and the fourth electrode portion 16D is a second output terminal.

As shown in FIG. 7, a first end of the first resistive portion 131 is connected to a first end of the second resistive portion 143 at a node P1. A second end of the first resistive portion 131 is connected to a second end of the second resistive portion 142 at a node P3. A second end of the second resistive portion 143 is connected to a second end of the second resistive portion 141 at a node P4. A first end of the second resistive portion 141 is connected to a first end of the second resistive portion 141 at a node P2. That is to say, the temperature sensor 1 according to this embodiment includes, as the second resistive portions, three second resistive portions 141, 142, 143. In addition, the first resistive portion 131 and the three second resistive portions 141, 142, 143 form a full bridge circuit. This enables amplifying detected voltage compared to a situation where a half bridge circuit is formed by the first resistive portion and the second resistive portions.

Furthermore, in the temperature sensor 1 according to this embodiment, the first electrode portion 16A is connected to the first resistive portion 131 and the second resistive portion 143 via a first connection portion 132 as shown in FIG. 7. The first connection portion 132 is a part, where the first resistive portion 131, the second resistive portion 143, and the first electrode portion 16A are connected to each other, of the first resistive layer 13. Furthermore, in the temperature sensor 1, the second electrode portion 16B is connected to the two second resistive portions 141, 142 via a second connection portion 133. The second connection portion 133 is apart, where the two second resistive portions 141, 142, and the second electrode portion 16B are connected to each other, of the second resistive layer 14. Furthermore, in the temperature sensor 1, the third electrode portion 16C is connected to the first resistive portion 131 and the second resistive portion 142 via a third connection portion 134. The third connection portion 134 is a part, where the first resistive portion 131, the second resistive portion 142, and the third electrode portion 16C are connected to each other, of the first resistive layer 13. Furthermore, in the temperature sensor 1, the fourth electrode portion 16D is connected to the two second resistive portions 141, 143 via a fourth connection portion 135. The fourth connection portion 135 is apart, where the two second resistive portions 141, 143, and the fourth electrode portion 16D are connected to each other, of the second resistive layer 14.

In the temperature sensor 1 having such a configuration, a power supply device (not shown) is connected between the first electrode portion 16A and the second electrode portion 16B such that the first electrode portion 16A serves as a cathode (positive electrode) and the second electrode portion 16B serves as an anode (negative electrode). When DC power is supplied from the power supply device to between the first electrode portion 16A and the second electrode portion 16B, a detected voltage (output signal) corresponding to a detected temperature is output from the third electrode portion 16C and the fourth electrode portion 16D to an external device (e.g., an external board). Then, a measuring circuit mounted on the external board calculates a detected temperature based on the detected voltage provided by the temperature sensor 1.

### (3) Method for Fabricating Temperature Sensor

Next, a method for fabricating the temperature sensor 1 according to an exemplary embodiment will be described.

The method for fabricating the temperature sensor 1 includes the following first to tenth steps.

The first step includes providing the supporting substrate 11. More specifically, the first step includes a wafer to be divided into respective supporting substrates 11 of a plurality of temperature sensors 1. The wafer may be, for example, a ceramic wafer. A material for the ceramic wafer used as the wafer may be, for example, sintered alumina with an alumina content equal to or greater than 96%.

The second step includes forming a planarization film 12 on the first principal surface of the wafer. More specifically, the second step includes, for example, applying a material for the planarization film 12 onto a first principal surface of the wafer and then firing the material, thereby forming the planarization film 12. The first principal surface of the wafer will eventually be the first principal surface 111 of the supporting substrate 11 in each of the plurality of temperature sensors 1.

The third step includes forming a first resistive layer 13 and second resistive layer 14 for each of the plurality of temperature sensors 1. More specifically, the third step includes, for example, forming the first resistive layer 13 and the second resistive layer 14 on the planarization film 12 by sputtering. The third step further includes patterning the first resistive portion 131 by photolithographic process, for example, such that the first resistive portion 131 of the first resistive layer 13 comes to have a meandering shape.

The fourth step includes forming a protective coating 15. More specifically, the fourth step includes, for example, applying paste of silicon dioxide by screen printing onto the planarization film 12 to partially cover the first resistive layer 13 and the second resistive layer 14 and then firing the paste, thereby forming the protective coating 15. In this embodiment, the fourth step includes forming the protective coating 15 that covers the assembly entirely but at least the part where the first resistive portion 131 is connected to the electrode portion 16 and the respective parts where the second resistive portions 141, 142, 143 are connected to the electrode portions 16.

The fifth step includes forming a plurality of upper surface electrodes 161 for each of the plurality of temperature sensors 1. More specifically, the fifth step includes, for example, forming, by sputtering, a copper-nickel based alloy film on the first principal surface of the wafer, thereby forming the plurality of upper surface electrodes 161 for each of the plurality of temperature sensors 1.

The sixth step includes forming a plurality of lower surface electrodes 163 for each of the plurality of temperature sensors 1. More specifically, the sixth step includes, for example, forming, by sputtering, a copper-nickel based alloy film on a second principal surface of the wafer, thereby forming the plurality of lower surface electrodes 163 for each of the plurality of temperature sensors 1. The second principal surface of the wafer will eventually be the second principal surface 112 of the supporting substrate 11 in each of the plurality of temperature sensors 1.

The seventh step includes cutting off the assembly of the plurality of temperature sensors 1, which have been formed integrally through the first to sixth steps, into respective temperature sensors 1. More specifically, the seventh step includes cutting off, by either laser cutting or dicing, for example, the assembly of the plurality of temperature sensors 1, which have been formed integrally, into respective temperature sensors 1.

The eighth step includes forming a plurality of end surface electrodes 162 on each of the plurality of temperature sensors 1 that have been cut off. More specifically, the eighth step includes, for example, forming, by sputtering, a copper-nickel based alloy film on the outer peripheral surfaces 113 of the supporting substrate 11, thereby forming the plurality of end surface electrodes 162 on each of the plurality of temperature sensors 1. As a result, the plurality of upper surface electrodes 161 and the plurality of lower surface electrodes 163 are connected to each other via the plurality of end surface electrodes 162.

The ninth step includes forming a plurality of first plating layers 17 on each of the plurality of temperature sensors 1. More specifically, the ninth step includes, for example, forming the plurality of first plating layers 17 that covers the plurality of electrode portions 16 in each of the plurality of temperature sensors 1.

The tenth step includes forming a plurality of second plating layers 18 on each of the plurality of temperature sensors 1. More specifically, the tenth step includes, for example, forming the plurality of second plating layers 18 that covers the plurality of first plating layers 17 in each of the plurality of temperature sensors 1.

The temperature sensor 1 according to this embodiment may be fabricated by performing the first through tenth steps described above.

### (4) Adjustment (Trimming) of Resistance Value

Next, it will be described with reference to FIGS. 2, 3, and 8 how the temperature sensor 1 according to this embodiment adjusts the resistance value.

### (4.1) If First Electrode Portion is Used as Power Supply Terminal

If the first electrode portion 16A is used as a power supply terminal as in the temperature sensor 1 according to this embodiment, then the second electrode portion 16B is used as a ground terminal.

If the third electrode portion 16C used as the first output terminal has a higher potential than the fourth electrode portion 16D used as the second output terminal, then adjustment portions 130 are provided for the first resistive portion 131 and another adjustment portion 140 is provided for the second resistive portion 141 as shown in FIGS. 2 and 3. The adjustment portions 130 are grooves provided for the first resistive portion 131. The adjustment portion 140 is a groove provided for the second resistive portion 141. In the example illustrated in FIGS. 2 and 3, the first resistive portion 131 has a plurality of (e.g., two in the example illustrated in FIGS. 2 and 3) adjustment portions 130. When viewed in plan in the third direction D3, one of the plurality of adjustment portions 130 has the shape of an ellipse which is elongate in the first direction D1 and the other adjustment portion 130 has the shape of an ellipse which is elongate in the second direction D2. In the example shown in FIGS. 2 and 3, the second resistive portion 141 has a single adjustment portion 140. When viewed in plan in the third direction D3, the adjustment portion 140 has an L shape. This enables equalizing the potential at the third electrode portion 16C with the potential at the fourth electrode portion 16D. In this case, the first resistive portion 131 and the second resistive portion 141 are specified resistive portions.

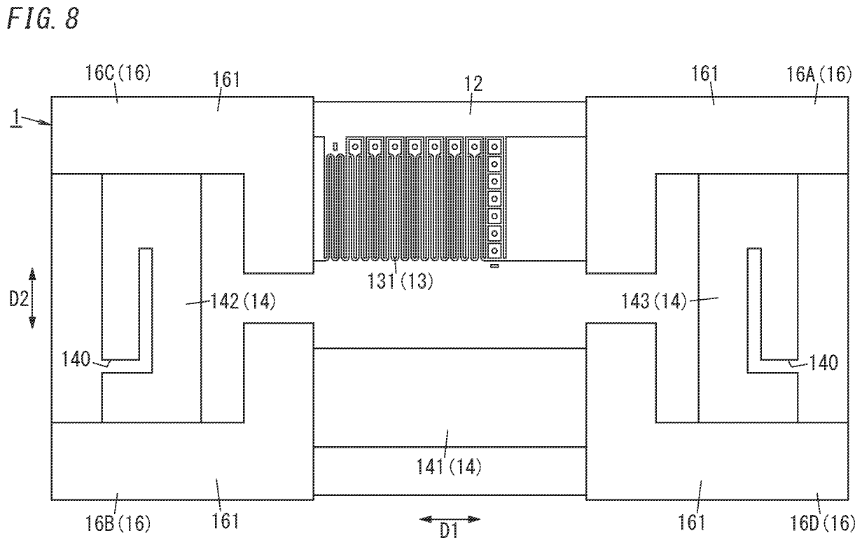

On the other hand, if the fourth electrode portion 16D has a higher potential than the third electrode portion 16C, then an adjustment portion 140 is provided for each of the two second resistive portions 142, 143 as shown in FIG. 8. The adjustment portion 140 is a groove provided through each of the second resistive portions 142, 143. In the example shown in FIG. 8, each of the second resistive portions 142, 143 has a single adjustment portion 140. When viewed in plan in the third direction D3, each adjustment portion 140 has an L shape. This enables equalizing the potential at the third electrode portion 16C with the potential at the fourth electrode portion 16D. In this case, the two second resistive portions 142, 143 are specified resistive portions.

### (4.2) If Second Electrode Portion is Used as Power Supply Terminal

If the second electrode portion 16B is used as a power supply terminal, then the first electrode portion 16A is used as a ground terminal.

If the third electrode portion 16C used as the first output terminal has a higher potential than the fourth electrode portion 16D used as the second output terminal, then an adjustment portion 140 is provided for each of the two second resistive portions 142, 143 as shown in FIG. 8. The adjustment portion 140 is a groove provided through each of the second resistive portions 142, 143. In the example shown in FIG. 8, each of the second resistive portions 142, 143 has a single adjustment portion 140. When viewed in plan in the third direction D3, each adjustment portion 140 has an L shape. This enables equalizing the potential at the third electrode portion 16C with the potential at the fourth electrode portion 16D. In this case, the two second resistive portions 142, 143 are specified resistive portions.

On the other hand, if the fourth electrode portion 16D has a higher potential than the third electrode portion 16C, then adjustment portions 130 are provided for the first resistive portion 131 and another adjustment portion 140 is provided for the second resistive portion 141 as shown in FIGS. 2 and 3. The adjustment portions 130 are grooves provided for the first resistive portion 131. The adjustment portion 140 is a groove provided for the second resistive portion 141. In the example illustrated in FIGS. 2 and 3, the first resistive portion 131 has a plurality of (e.g., two in the example illustrated in FIGS. 2 and 3) adjustment portions 130. When viewed in plan in the third direction D3, one of the plurality of adjustment portions 130 has the shape of an ellipse which is elongate in the first direction D1 and the other adjustment portion 130 has the shape of an ellipse which is elongate in the second direction D2. In the example shown in FIGS. 2 and 3, the second resistive portion 141 has a single adjustment portion 140. When viewed in plan in the third direction D3, the adjustment portion 140 has an L shape. This enables equalizing the potential at the third electrode portion 16C with the potential at the fourth electrode portion 16D. In this case, the first resistive portion 131 and the second resistive portion 141 are specified resistive portions.

### (5) Advantages

In the temperature sensor 1 according to this embodiment, the first resistive portion 131 and the plurality of second resistive portions 141, 142, 143 are formed on the planarization film 12 that has been formed on the supporting substrate 11 as described above. This allows the first resistive portion 131 and the plurality of second resistive portions 141, 142, 143 to be planarized more easily than in a situation where the first resistive portion 131 and the plurality of second resistive portions 141, 142, 143 are formed directly on the supporting substrate 11 with no planarization film 12 interposed between the resistive portions 131, 141, 142, 143 and the substrate 11. Consequently, the surface roughness of the supporting substrate 11 is not directly reflected on the surface roughness of the first resistive portion 131 and the plurality of second resistive portions 141, 142, 143, thus reducing the chances of causing a decline in the temperature detection accuracy.

In the temperature sensor 1 according to this embodiment, the planarization film 12 includes at least one material selected from the group consisting of zinc oxide, magnesium oxide, beryllium oxide, aluminum nitride, boron nitride, silicon nitride, and diamond as described above. This enables bringing the thermal conductivity and coefficient of linear expansion of the planarization film 12 closer to the thermal conductivity and coefficient of linear expansion of the supporting substrate 11.

In the temperature sensor 1 according to this embodiment, the material for the first resistive portion 131 includes platinum as described above. This enables obtaining a good temperature coefficient of resistance with respect to the temperature.

In the temperature sensor 1 according to this embodiment, the material for the second resistive portions 141, 142, 143 includes an NiCrAlSi alloy as described above. This allows each of the second resistive portions 141, 142, 143 to be used as a reference resistor, of which the temperature coefficient of resistance is substantially equal to zero.

In the temperature sensor 1 according to this embodiment, the first resistive portion 131 and the three second resistive portions 141, 142, 143 form a full bridge circuit as described above. This enables amplifying detected voltage compared to a situation where a half bridge circuit is formed by the first resistive portion and the second resistive portions.

The temperature sensor 1 according to this embodiment further includes the third electrode portion 16C and the fourth electrode portion 16D, through which an output signal of the full bridge circuit formed by the first resistive portion 131 and the three second resistive portions 141, 142, 143 is delivered to an external device as described above. This allows the output signal of the full bridge circuit to be delivered to the external device.

In the temperature sensor 1 according to this embodiment, the first resistive portion 131 and the second resistive portion 141 each have the adjustment portion 130, 140 as described above. This enables adjusting the resistance values of the first resistive portion 131 and the second resistive portion 141, thus allowing the respective potentials at the third electrode portion 16C and the fourth electrode portion 16D to be equalized with each other. Furthermore, each of the adjustment portions 130, 140 is a groove provided through either the first resistive portion 131 or the second resistive portion 141. This makes it easier to adjust the respective resistance values of the first resistive portion 131 and the second resistive portion 141.

### (6) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. Next, variations of the exemplary embodiment will be enumerated one after another. Note that the variations to be described below may be adopted in combination as appropriate.

In the exemplary embodiment described above, the material for the first resistive portion 131 is platinum. However, the material for the first resistive portion 131 does not have to be platinum. Alternatively, the material for the first resistive portion 131 may include nickel (Ni), copper (Cu), or a nickel-cobalt (NiCo) alloy, for example. Still alternatively, the material for the first resistive portion 131 may include two or more selected from the group consisting of platinum, nickel, copper, and a nickel-cobalt alloy. In short, the material for the first resistive portion 131 may include at least one selected from the group consisting of platinum, nickel, copper, and a nickel-cobalt alloy.

In the exemplary embodiment described above, the adjustment portions 130 of the first resistive portion 131 and the adjustment portion 140 of the second resistive portion 141 each have a groove shape. However, this shape is only an example and should not be construed as limiting. That is to say, the adjustment portions 130, 140 may have any shape as long as the adjustment portions 130, 140 allow the resistance values of the first resistive portion 131 and the second resistive portion 141 to be adjusted.

In the exemplary embodiment described above, a full bridge circuit is formed by the single first resistive portion 131 and the three second resistive portions 141, 142, 143. Alternatively, a half bridge circuit may be formed by the single first resistive portion 131 and a single second resistive portion, for example.

In the exemplary embodiment described above, the adjustment portions are provided for two resistive portions (namely, either the first resistive portion 131 and the second resistive portion 141 or the two second resistive portions 142, 143). However, this is only an example and should not be construed as limiting. Rather, the adjustment portion needs to be provided for at least one of these two resistive portions. For example, if the first resistive portion 131 and the second resistive portion 141 are specified resistive portions, then the adjustment portion 130 may be provided for only the first resistive portion 131 or the adjustment portion 140 may be provided for only the second resistive portion 141.

In the exemplary embodiment described above, the material for the electrode portions 16 is a copper-nickel based alloy. However, the material for the electrode portions 16 does not have to be the copper-nickel based alloy but may also be, for example, an alloy containing gold.

### Aspects

The exemplary embodiment and its variations described above are specific implementations of the following aspects of the present disclosure.

A temperature sensor (1) according to a first aspect includes an alumina substrate (11), a planarization film (12), a first resistive portion (131), and at least one second resistive portion (141, 142, 143). The planarization film (12) contains alumina as a main component thereof and is formed on the alumina substrate (11). The first resistive portion (131) is formed on the planarization film (12). The at least one second resistive portion (141, 142, 143) is formed on the planarization film (12) and forms a bridge circuit along with the first resistive portion (131).

This aspect may reduce the chances of causing a decline in temperature detection accuracy.

In a temperature sensor (1) according to a second aspect, which may be implemented in conjunction with the first aspect, the planarization film (12) contains a filler.

This aspect may bring the thermal conductivity and coefficient of linear expansion of the planarization film (12) closer to the thermal conductivity and coefficient of linear expansion of the alumina substrate (11).

In a temperature sensor (1) according to a third aspect, which may be implemented in conjunction with the second aspect, the filler includes at least one material selected from the group consisting of zinc oxide, magnesium oxide, beryllium oxide, aluminum nitride, boron nitride, silicon nitride, and diamond.

This aspect may bring the thermal conductivity and coefficient of linear expansion of the planarization film (12) closer to the thermal conductivity and coefficient of linear expansion of the alumina substrate (11).

In a temperature sensor (1) according to a fourth aspect, which may be implemented in conjunction with any one of the first to third aspects, a material for the first resistive portion (131) includes at least one selected from the group consisting of platinum, nickel, copper, and a nickel-cobalt alloy.

This aspect enables obtaining a good temperature coefficient of resistance with respect to the temperature.

In a temperature sensor (1) according to a fifth aspect, which may be implemented in conjunction with any one of the first to fourth aspects, a material for the at least one second resistive portion (141, 142, 143) includes an NiCrAlSi alloy.

This aspect allows the second resistive portion (141, 142, 143) to be used as a reference resistor, of which the temperature coefficient of resistance is substantially equal to zero.

In a temperature sensor (1) according to a sixth aspect, which may be implemented in conjunction with any one of the first to fifth aspects, the at least one second resistive portion (141, 142, 143) includes three second resistive portions (141, 142, 143). The bridge circuit is a full bridge circuit made up of the first resistive portion (131) and the three second resistive portions (141, 142, 143).

This aspect enables amplifying detected voltage compared to a situation where the bridge circuit is a half bridge.

A temperature sensor (1) according to a seventh aspect, which may be implemented in conjunction with the sixth aspect, further includes a first electrode portion (16A), a second electrode portion (16B), a third electrode portion (16C), and a fourth electrode portion (16D). The first electrode portion (16A) and the second electrode portion (16B) supply power to the full bridge circuit. The third electrode portion (16C) and the fourth electrode portion (16D) deliver an output signal of the full bridge circuit to an external device.

This aspect allows the third electrode portion (16C) and the fourth electrode portion (16D) to deliver the output signal to an external device.

In a temperature sensor (1) according to an eighth aspect, which may be implemented in conjunction with any one of the first to seventh aspects, a specified resistive portion (such as the first resistive portion 131 and the second resistive portion 141) includes an adjustment portion (130, 140) to adjust a resistance value of the specified resistive portion. The specified resistive portion is at least one resistive portion selected from the group consisting of the first resistive portion (131) and the at least one second resistive portion (141, 142, 143).

This aspect allows the temperature sensor (1) to correct, by itself, a potential difference between detection electrodes of the bridge circuit, thus eliminating the need to make zero-point correction after the temperature sensor (1) has been mounted onto an external board.

In a temperature sensor (1) according to a ninth aspect, which may be implemented in conjunction with the eighth aspect, the adjustment portion (130, 140) is a groove provided for the specified resistive portion (such as the first resistive portion 131 and the second resistive portion 141).

This aspect enables adjusting the resistance value of the specified resistive portion simply by providing a groove for the specified resistive portion.

Note that the constituent elements according to the second to ninth aspects are not essential constituent elements for the temperature sensor (1) but may be omitted as appropriate.

### REFERENCE SIGNS LIST

1 Temperature Sensor
11 Supporting Substrate (Alumina Substrate)
12 Planarization Film
16A First Electrode Portion
16B Second Electrode Portion
16C Third Electrode Portion
16D Fourth Electrode Portion
130 Adjustment Portion
131 First Resistive Portion (Specified Resistive Portion)
140 Adjustment Portion
141, 142, 143 Second Resistive Portion (Specified Resistive Portion)

1. A temperature sensor comprising:
an alumina substrate;
a planarization film containing alumina as a main component thereof and formed on the alumina substrate;
a first resistive portion formed on the planarization film; and
at least one second resistive portion formed on the planarization film and forming a bridge circuit along with the first resistive portion.

2. The temperature sensor of claim 1, wherein
the planarization film contains a filler.

3. The temperature sensor of claim 2, wherein
the filler includes at least one material selected from the group consisting of zinc oxide, magnesium oxide, beryllium oxide, aluminum nitride, boron nitride, silicon nitride, and diamond.

4. The temperature sensor of claim 1, wherein
a material for the first resistive portion includes at least one selected from the group consisting of platinum, nickel, copper, and a nickel-cobalt alloy.

5. The temperature sensor of claim 1, wherein
a material for the at least one second resistive portion includes an NiCrAlSi alloy.

6. The temperature sensor of claim 1, wherein
the at least one second resistive portion includes three second resistive portions, and
the bridge circuit is a full bridge circuit comprised of the first resistive portion and the three second resistive portions.

7. The temperature sensor of claim 6, further comprising:
a first electrode portion and a second electrode portion configured to supply power to the full bridge circuit; and
a third electrode portion and a fourth electrode portion configured to deliver an output signal of the full bridge circuit to an external device.

8. The temperature sensor of claim 1, wherein
at least one resistive portion selected from the group consisting of the first resistive portion and the at least one second resistive portion is a specified resistive portion, and
the specified resistive portion has an adjustment portion configured to adjust a resistance value of the specified resistive portion.

9. The temperature sensor of claim 8, wherein
the adjustment portion is a groove provided for the specified resistive portion.
